(19) United States
(12) Patent Application Publication
(10) Pub. No.: US 2026/0321520 A1
(43) Pub. Date: Oct. 15, 2026

(54) Hybrid Electrolytic Capacitor Apparatus and Method

(71) Applicant: AA Power Inc., Boston, MA (US)

(72) Inventor: Qun Lu, Lexington, MA (US)

(21) Appl. No.: 19/643,587

(22) Filed: Apr. 9, 2026

Related U.S. Application Data
(60) Provisional application No. 63/787,628, filed on Apr. 11, 2025.

(51) Int. Cl. H01G 11/76; H01G 11/04; H01G 11/12; H01G 11/18; H01G 11/24; H01G 11/78; H01G 13/00

(52) U.S. Cl. CPC H01G 11/76; H01G 11/04; H01G 11/12; H01G 11/18; H01G 11/24; H01G 11/78; H01G 13/006

(57) ABSTRACT

A hybrid capacitor may include a cathode foil, an anode foil, a negative pole, and a positive pole. The cathode foil is connected to the negative pole via laser welding. The anode foil is connected to the positive pole via laser welding.

### PRIORITY

This application claims the benefit of U.S. Provisional Application No. 63/787,628, filed on April 11, 2025, entitled “Hybrid Electrolytic Capacitor Apparatus and Method,” which application is hereby incorporated herein by reference.

### TECHNICAL FIELD

The present disclosure relates generally to the field of electrolytic capacitors, and in particular embodiments, to a hybrid electrolytic capacitor apparatus and method.

### BACKGROUND

Traditional electrolytic capacitors use a “cow horn” lead out method, in which the pins of each capacitor extend downward through a printed circuit board 102 for electrical connection. The series and parallel connections between capacitors are implemented through PCB routing. As illustrated in FIG. 1, multiple electrolytic capacitors 101 are mounted upright on the PCB, with their respective pins 103 extending through the PCB board. This structure leads to a longer current path and increases reliance on PCB layout for current distribution and collection. The size of the PCB, along with the pins of the capacitors extending through it, reduces space utilization and limits design compactness.

Furthermore, the copper foil in a PCB, which serves as the primary conductive path between components, has limited thickness and therefore insufficient current-carrying capacity, resulting in thermal stress that degrades capacitor reliability and accelerates aging. As illustrated in FIG. 2, traditional electrolytic capacitors utilize a cold riveting structure with conductive strips 201/202 to connect internal electrodes to external terminals. This structure has a relatively small conductive cross-sectional area and a relatively long current path, leading to poor current collection efficiency and further contributing to thermal buildup and performance degradation.

It is thus desirable to develop techniques and mechanisms to improve performance of fuel cell systems in various aspects, and to facilitate utilization of fuel cell systems.

### SUMMARY

Technical advantages are generally achieved, by embodiments of this disclosure which describe a hybrid electrolytic capacitor apparatus and method.

In accordance with one aspect of the present disclosure, a hybrid capacitor is provided that includes: a cathode foil, an anode foil, a negative pole, and a positive pole. The cathode foil is connected to the negative pole via laser welding. The anode foil is connected to the positive pole via laser welding.

In accordance with one aspect of the present disclosure, a hybrid capacitor module is provided that includes: a plurality of hybrid capacitors, a positive busbar, a negative busbar, and a connector configured to interface with external circuits. Each of the plurality of hybrid capacitors comprises a negative pole and a positive pole. The negative poles of the plurality of hybrid capacitors are connected to the negative busbar. The positive poles of the plurality of hybrid capacitors are connected to the positive busbar.

In accordance with another aspect of the present disclosure, a method for forming a hybrid electrolytic capacitor is provided that includes: providing a plurality of hybrid capacitors, each comprising a positive pole and a negative pole; arranging the plurality of hybrid capacitors side by side in parallel; connecting the negative poles of the plurality of hybrid capacitors to a negative busbar via laser welding; connecting the positive poles of the plurality of hybrid capacitors to a positive busbar via laser welding; enclosing the plurality of hybrid capacitors and the busbars within a housing; and providing a connector configured to interface with external circuits and to secure the hybrid capacitor module within the housing.

Features described in the context of one embodiment may be used in combination with other embodiments. Each of the optional features described above in the context of the apparatus may be used in combination with the method.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a perspective view illustrating traditional electrolytic capacitors mounted on a printed circuit board (PCB);

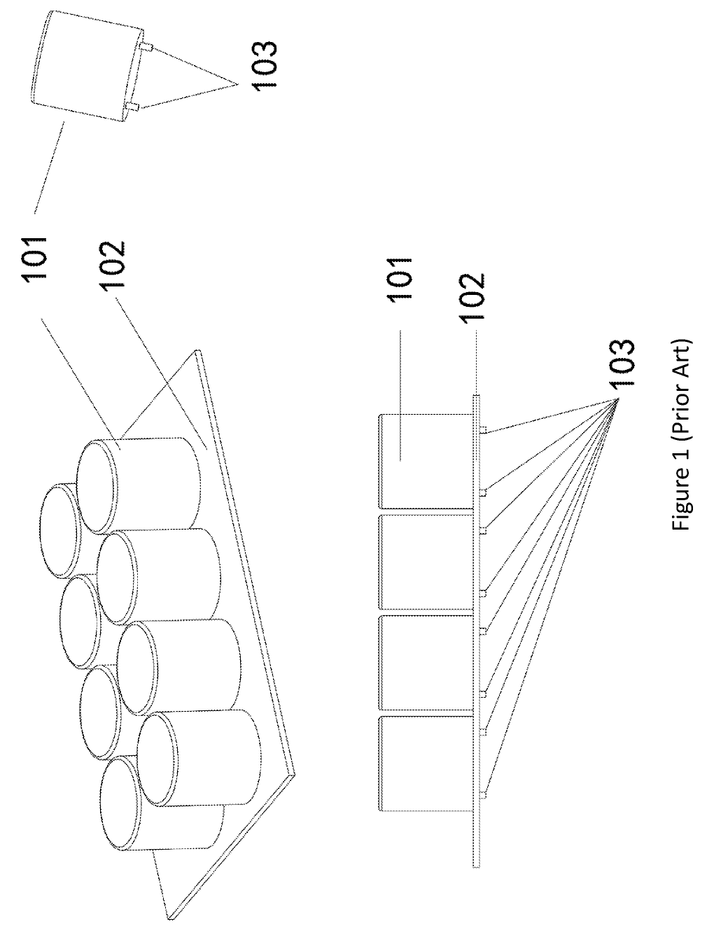

FIG. 2 is an exploded view of the traditional electrolytic capacitors shown in FIG. 1;

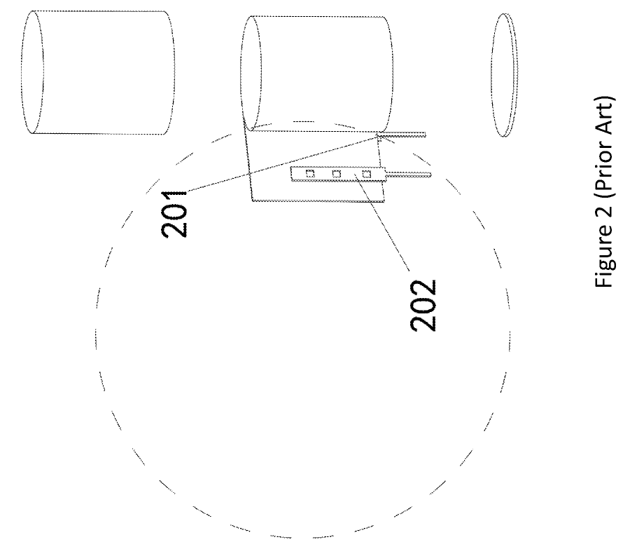

FIG. 3 is an exploded view of an example hybrid electrolytic capacitor in accordance with various embodiments of the present disclosure;

FIG. 4 is an exploded view of an example hybrid electrolytic capacitor in accordance with various embodiments of the present disclosure;

FIG. 5 is an exploded view of an example hybrid electrolytic capacitor in accordance with various embodiments of the present disclosure;

FIG. 6 is an exploded view of an example hybrid capacitor module in accordance with various embodiments of the present disclosure;

FIG. 7 is an example hybrid capacitor bank in accordance with various embodiments of the present disclosure;

FIG. 8 is an example hybrid capacitor bank in accordance with various embodiments of the present disclosure;

FIG. 9 is an example hybrid capacitor module and an example hybrid capacitor bank in accordance with various embodiments of the present disclosure; and

FIG. 10 is a flowchart of an example method 1000 for forming a hybrid capacitor module in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood within the scope of this disclosure. It is therefore intended that the appended claims encompass any such modifications or embodiments.

The present disclosure will be described with respect to preferred embodiments in a specific context, namely a hybrid electrolytic capacitor apparatus and method. Hereinafter, various embodiments will be explained in detail with reference to the accompanying drawings. The terms of “hybrid electrolytic capacitor” and “hybrid capacitor” are used interchangeably in the present disclosure.

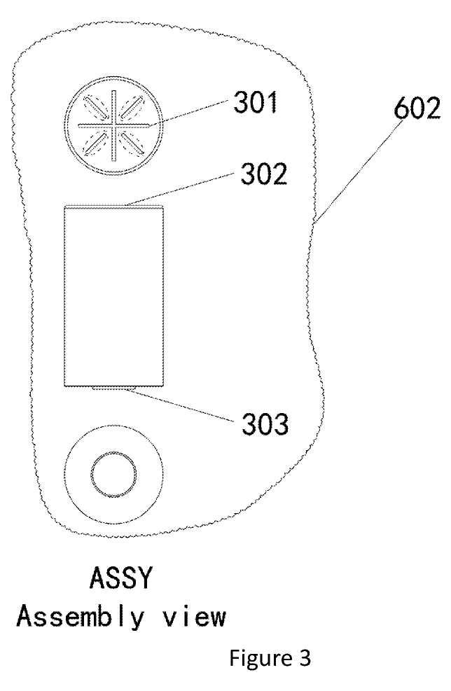

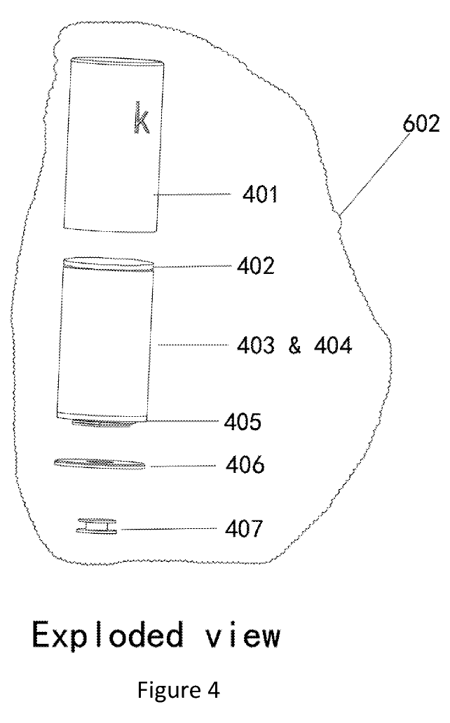

FIGS. 3 and 4 illustrate an example hybrid electrolytic capacitor 602 in accordance with various embodiments of the present disclosure. As illustrated in FIGS. 3 and 4, the hybrid electrolytic capacitor 602 comprises a cylindrical case 401, a cathode foil 403, an anode foil 404, a positive pole 303, a negative pole 302, a top cover 406, and a bottom plate 407. The positive pole 303 is located at one end of the hybrid electrolytic capacitor 602 and is supported by the bottom plate 407. In some embodiments, the positive pole 303 may be integrated to or may pass through the bottom plate 407. The negative pole 302 is located at the opposite end of the hybrid electrolytic capacitor 602. In some embodiments, the negative pole 302 may be integrated to or may pass through the top cover 406. The anode foil 404 is connected to the positive pole 303 through laser welding. The cathode foil 403 is connected to the negative pole 302 through laser welding.

As illustrated in FIG. 4, the hybrid capacitor 602 may further comprise a negative ear 402, and a positive ear 405. In some embodiments, the negative ear 402 is an integral extension of the cathode foil 403, and the positive ear 405 is an integral extension of the anode foil 404. The positive ear 405 is welded to the positive pole 303, and the negative ear 402 is welded to the negative pole 302.

In some embodiments, hybrid capacitors 602 adopt all aluminum caps instead of rubber caps, which increases the structural strength, especially in terms of electrolyte leakage rate, by more than 10 times.

In some embodiments, hybrid capacitors 602 use aluminum terminal welding and lead out method at both ends. Hybrid capacitors only need to be welded with aluminum strips when combined, while traditional capacitors require PCB soldering. Compared with the space utilization rate of mold assembly, the space utilization rate of hybrid capacitors can be increased by 10%, and the mold assembly cost can be reduced by 15%.

In terms of product specifications, the internal resistance of hybrid capacitors 602 is 10% of traditional capacitors 101, the ripple current capability is 10 times that of traditional capacitors 101, and the lifespan is more than twice that of traditional capacitors 101.

In terms of structure, the hybrid capacitor 602 has a current collection capacity 20 times higher than the traditional capacitor 101. Compared with the current real case (450V100uF product), the distance from the electrode of the hybrid capacitor 602 to the current collection welding point is less than 50mm, the distance from the electrode of the traditional capacitor 101 to the current collection welding point is 1000mm, the current collection welding point area of the hybrid capacitor 602 is 76 square millimeters, and the current collection welding area of the traditional capacitor 101 is 5 square millimeters.

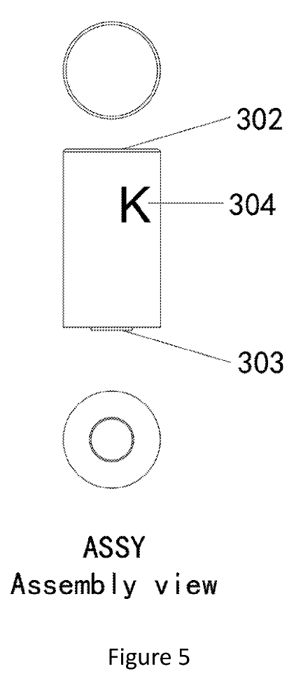

The hybrid capacitor 602 may further comprise an explosion-proof valve 301/304. In some embodiments, the explosion-proof valve 301 may be integrated into the top cover of the hybrid capacitor 602. In some other embodiments, the explosion-proof valve 304 may be placed on the side of the hybrid capacitor 602. As illustrated in FIG. 5, the explosion-proof valve 304 is placed on the side of the hybrid capacitor 602.

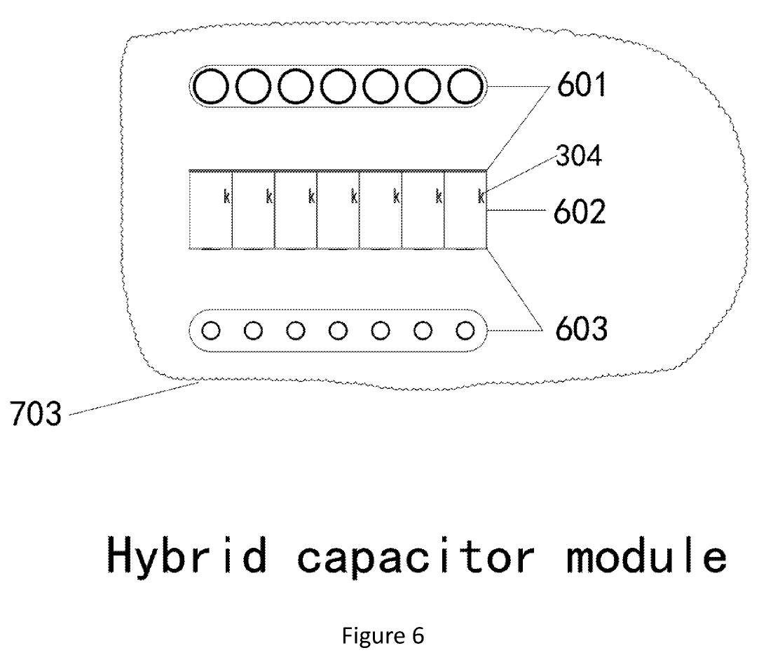

The hybrid capacitor 602 is assembled by directly welding aluminum bars 601/603 at the positive 303 and negative 302 ends, which saves PCB 102 and lead pin size 103. At the same time, thicker aluminum bars can ensure greater current carrying capacity and mechanical strength. FIG. 6 is an exploded view of an example hybrid capacitor module 703 in accordance with various embodiments of the present disclosure.

As illustrated in FIG. 6, a hybrid capacitor module 703 comprises a plurality of hybrid capacitors 602, a negative busbar 601, and a positive busbar 603. In some of the embodiments, both the positive busbar 603 and negative busbar 601 are made of aluminum. In some embodiments, the plurality of hybrid capacitors 602 are placed side by side in parallel. The negative poles 302 of the plurality of hybrid capacitors 602 are connected to the negative busbar 601 via laser welding. The positive poles 303 of the plurality of hybrid capacitors 602 are connected to the positive busbar 603 via laser welding. As illustrated in FIG. 6, the explosion-proof valves 304 of the hybrid capacitors 602 are positioned on the side of each hybrid capacitor 602. However, in alternative embodiments, the explosion-proof valves 301 may be located on the top cover of each hybrid capacitor 602, as shown in FIG. 3.

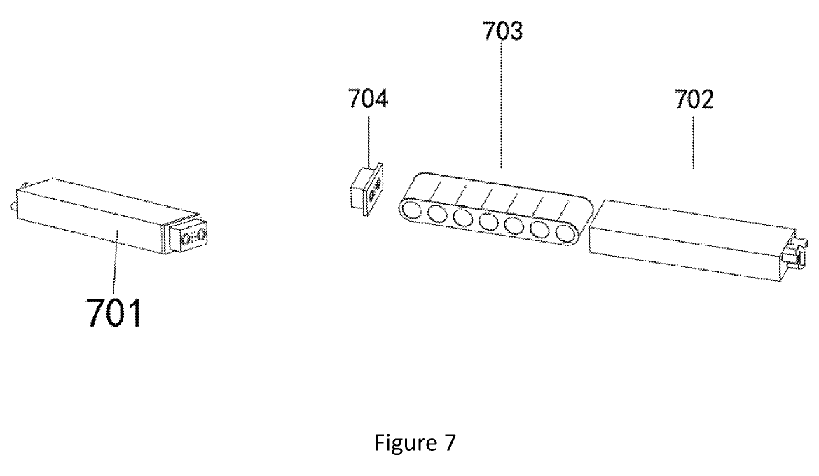

In some embodiments, as illustrated in FIG. 7, a hybrid capacitor bank 701 may comprise a bank case 702, a hybrid capacitor module 703 as illustrated in FIG. 6, and a connector 704. The hybrid capacitor module 703 is enclosed within the bank case 702, which provides mechanical protection and electrical insulation. The connector 704 includes a positive terminal and a negative terminal. The positive terminal of the connector is electrically connected to the positive busbar 603 of the hybrid capacitor module 703, and the negative terminal of the connector is electrically connected to the negative busbar 601 of the hybrid capacitor module 703. The connector 704 is configured to interface with external circuits and to secure the hybrid capacitor module 703 within the case 702, thereby forming an integrated and compact capacitor bank 701 assembly. As illustrated in FIG. 7, the connector 704 may have a width that is equal to, or substantially equal to, a width of the bank case 702.

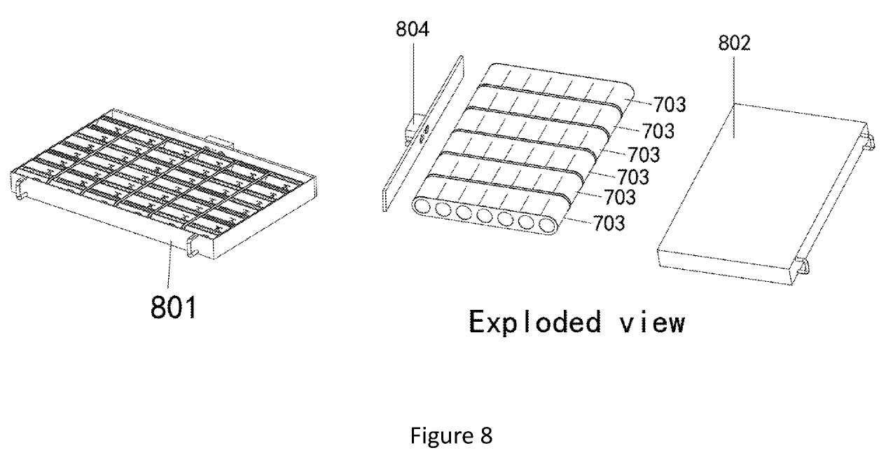

In some embodiments, as illustrated in FIG. 8, a hybrid capacitor bank 801 comprises a bank case 802, a plurality of hybrid capacitor modules 703, and a connector 804. The plurality of hybrid capacitor modules 703 are placed side by side within the bank case 802. The connector 804 includes a positive terminal and a negative terminal. The positive terminal of the connector is electrically connected to the positive busbars 603 of the plurality of hybrid capacitor modules 703, and the negative terminal of the connector is electrically connected to the negative busbars 601 of the plurality of hybrid capacitor modules 703. The connector is configured to secure the plurality of hybrid capacitor modules 703 inside the bank case 802 and to provide electrical interfacing with external systems. As illustrated in FIG. 8, the connector 804 may have a width that is equal to, or substantially equal to, a width of the bank case 802. The hybrid capacitor modules 703 may be configured in parallel, series, or in a series-parallel combination, depending on system voltage and energy storage requirements.

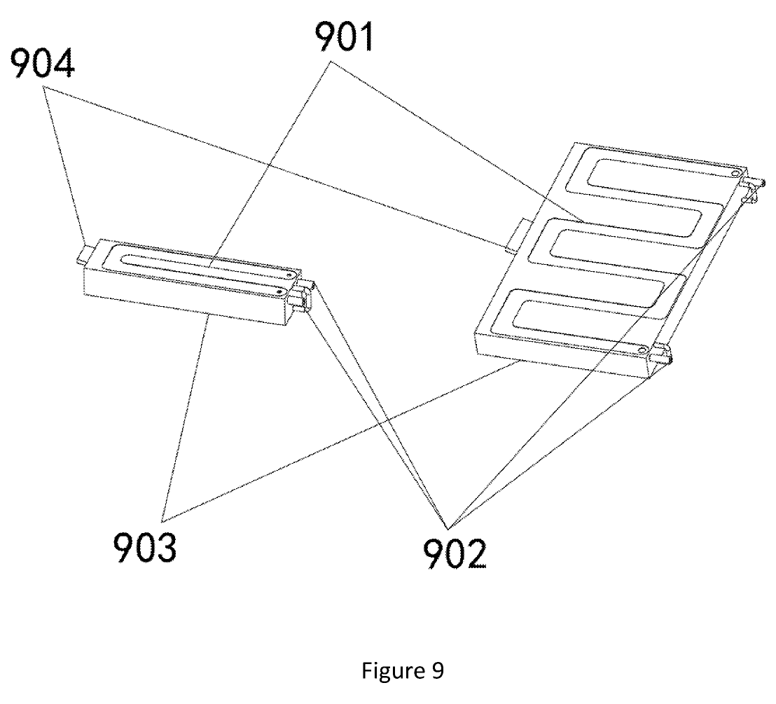

Furthermore, liquid cooling may be employed to enhance heat dissipation. As illustrated in FIG. 9, liquid channels 901 can be integrated into or installed on the outer shell of a hybrid capacitor module 703 or a hybrid capacitor bank 801. As illustrated in FIG. 9, the liquid connect 902 comprises an inlet, an outlet, and a liquid connector 904. The shape or path of the liquid channel may be of any suitable configuration, such as U-shaped, or looped, depending on thermal and structural requirements. Liquid coolant enters the liquid channel through the inlet, circulates through the channel structure, and exits through the outlet, thereby carrying heat away from the capacitor assembly. The liquid connector 904 is configured to provide interfacing with external systems.

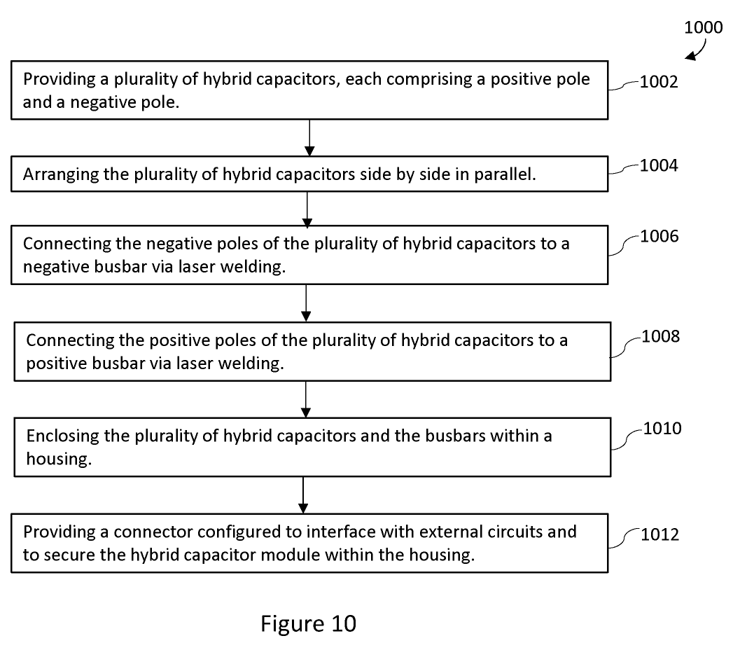

FIG. 10 is a flowchart of an example method 1000 for forming a hybrid capacitor module in accordance with various embodiments of the present disclosure.

At step 1002, providing a plurality of hybrid capacitors, each comprising a positive pole and a negative pole;

At step 1004, arranging the plurality of hybrid capacitors side by side in parallel;

At step 1006, connecting the negative poles of the plurality of hybrid capacitors to a negative busbar via laser welding;

At step 1008, connecting the positive poles of the plurality of hybrid capacitors to a positive busbar via laser welding;

At step 1010, enclosing the plurality of hybrid capacitors and the busbars within a housing; and

At step 1012, providing a connector configured to interface with external circuits and to secure the hybrid capacitor module within the housing.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A hybrid capacitor, comprising:
a cathode foil;
an anode foil;
a negative pole; and
a positive pole, wherein the cathode foil is connected to the negative pole via laser welding, and the anode foil is connected to the positive pole via laser welding.

2. The hybrid capacitor of claim 1, further comprising an explosion-proof valve, wherein the explosion-proof valve is positioned on a side of the hybrid capacitor.

3. The hybrid capacitor of claim 1, further comprising an explosion-proof valve, wherein the explosion-proof valve is integrated into a top cover of the hybrid capacitor.

4. The hybrid capacitor of claim 1, further comprising a cap positioned at one end of the hybrid capacitor, wherein the cap is made of aluminum.

5. The hybrid capacitor of claim 1, wherein the cathode foil comprises an extended portion welded to the negative pole, and the anode foil comprises an extended portion welded to the positive pole.

6. A hybrid capacitor module, comprising:
a plurality of hybrid capacitors, each of the plurality of hybrid capacitors comprising a negative pole and a positive pole;
a positive busbar;
a negative busbar; and
a connector configured to interface with external circuits, wherein the negative poles of the plurality of hybrid capacitors are connected to the negative busbar, and the positive poles of the plurality of hybrid capacitors are connected to the positive busbar.

7. The hybrid capacitor module of claim 6, wherein the negative poles of the plurality of hybrid capacitors are connected to the negative busbar via laser welding and the positive poles of the plurality of hybrid capacitors are connected to the positive busbar via laser welding.

8. The hybrid capacitor module of claim 6, further comprising a housing, wherein the plurality of hybrid capacitors are arranged side by side in parallel and enclosed within the housing.

9. The hybrid capacitor module of claim 6, wherein the positive busbar and the negative busbar are made of aluminum.

10. The hybrid capacitor module of claim 6, wherein the plurality of hybrid capacitors are arranged side by side in parallel as a standalone module.

11. The hybrid capacitor module of claim 6, wherein the negative busbar is electrically connected to outer shells of the plurality of hybrid capacitors.

12. The hybrid capacitor module of claim 6, further comprising a liquid channel.

13. The hybrid capacitor module of claim 12, wherein the liquid channel is disposed on an outer shell and configured for coolant circulation to dissipate heat.

14. The hybrid capacitor module of claim 12, wherein the liquid channel is connected to the negative busbar for heat dissipation.

15. The hybrid capacitor module of claim 6, wherein each of the plurality of hybrid capacitors further comprises an explosion-proof valve positioned on a side of the respective hybrid capacitor.

16. The hybrid capacitor module of claim 12, wherein the liquid channel is made of copper, aluminum, or an alloy thereof.

17. A method, comprising:
providing a plurality of hybrid capacitors, each of the plurality of hybrid capacitors comprising a positive pole and a negative pole;
arranging the plurality of hybrid capacitors side by side in parallel;
connecting negative poles to a negative busbar and positive poles to a positive busbar by laser welding;
enclosing the plurality of hybrid capacitors within a housing; and
providing a connector configured to interface with external circuits and to secure the hybrid capacitor module within the housing.

18. The method of claim 17, wherein the negative busbar and the positive busbar are made of copper, aluminum, or an alloy thereof.

19. The method of claim 17, further comprising:
installing a liquid channel on the housing, and circulating liquid coolant through the liquid channel to dissipate heat generated from the plurality of hybrid capacitors.

20. The method of claim 17, wherein each of the plurality of hybrid capacitors further comprises a cathode foil and an anode foil, wherein the cathode foil is connected to the negative pole via laser welding, and the anode foil is connected to the positive pole via laser welding.
